(19) United States
(12) Patent Application Publication
(10) Pub. No.: US 2009/0085832 A1
(43) Pub. Date: Apr. 2, 2009

(54) Direct view 3D display and method

(76) Inventor: William E. Glenn, Lighthouse Point, FL (US)

Correspondence Address: MARTIN NOVACK, 16355 VINTAGE OAKS LANE, DELRAY BEACH, FL, 33484, US

(21) Appl. No.: 12/284,896

(22) Filed: Sep. 25, 2008

Related U.S. Application Data
(60) Provisional application No. 60/997,001, filed on Sep. 28, 2007.

(51) Int. Cl. G09G 5/00

(52) U.S. Cl. 345/1.3

(57) ABSTRACT

A method for three-dimensional viewing includes the following steps: providing first and second stereoscopic video component signals representative of a three-dimensional scene; providing first and second orthogonally oriented two-dimensional liquid crystal display panels, and respectively coupling the first and second video component signals to the first and second LCD panels to produce first and second two-dimensional polarized images; providing a 90 degree polarization rotation with respect to one of the first and second images, so that the first and second images are orthogonally polarized; providing a polarization-sensitive reflector angularly between the first and second orthogonally polarized images to superimpose and direct both of the first and second orthogonally polarized images toward a viewer; and viewing the superimposed first and second orthogonally polarized images with Polaroid glasses.

### RELATED APPLICATION

Priority is claimed from U.S. Provisional Patent Application No. 60/997,001, filed Sep. 28, 2007.

### FIELD OF THE INVENTION

This invention relates to the methods and apparatus for displaying stereoscopic three dimensional video component signals for viewing of three dimensional images.

### BACKGROUND OF THE INVENTION

During the 1950's, a three dimensional display was devised that utilized two cathode ray tube (CRT) displays. One was facing the viewer and the other was facing up. Two polarizers were used to polarize the images at polarizations ninety degrees apart. A half-silvered mirror was placed at 45 degrees between the displays so that the two images were superimposed when viewed by the viewer. The mirror reflected one direction of polarization and transmitted the orthogonal direction of polarization. By wearing Polaroid glasses, the viewer saw a 3D image when a stereoscopic pair of images were respectively displayed on the CRTs. Since the field of view was quite small, the images looked like a puppet show in a one foot wide puppet theatre. However, even if larger displays could have been used, the system had the disadvantage that there was the need to polarize each image, which resulted in substantial light loss. The half-silvered mirror also contributed to loss of light.

To produce theatrical 3D images from an IMAX camera (e.g. in 4K format) one can use two Sony 4K theatre projectors with the projected images being viewed with Polaroid glasses. This takes a minimum of a 16′ special screen and at least a 40′ throw for the projector. This works for theatrical applications but is rather cumbersome for most of the applications of the type where the cameras are used for surveillance or for program production. The display must have a wide field of view (60 degrees or more) to be sure that the viewer's eyes do not limit the perception of detail in the image. For viewing in a studio or control console, the image needs to still be over 60 degrees but at normal viewing distance.

It is among the objects of the present invention to provide an improved large screen “direct view” (i.e., non-projection) 3D display and method, which overcomes problems and limitations of prior art approaches as summarized above.

### SUMMARY OF THE INVENTION

In accordance with a form of the technique of the invention, a method is set forth for three-dimensional viewing, including the following steps: providing first and second stereoscopic video component signals representative of a three-dimensional scene; providing first and second orthogonally oriented two-dimensional liquid crystal display panels, and respectively coupling said first and second video component signals to said first and second LCD panels to produce first and second two-dimensional polarized images; providing a 90 degree polarization rotation with respect to one of said first and second images, so that said first and second images are orthogonally polarized; providing a polarization-sensitive reflector angularly between said first and second orthogonally polarized images to superimpose and direct both of said first and second orthogonally polarized images toward a viewer; and viewing said superimposed first and second orthogonally polarized images with Polaroid glasses. In a preferred embodiment of this form of the invention, the step of providing a 90 degree polarization rotation comprises providing a 90 degree twist plate over one of said first or second LCD panels. In this embodiment, the step of providing a polarization sensitive reflector comprises providing a polarization sensitive mirror at an angle of 45 degrees between said orthogonally oriented LCD panels.

In accordance with a further form of the invention, an apparatus is provided for receiving first and second stereoscopic video component signals representative of a three-dimensional scene, and providing orthogonally polarized images for stereoscopic viewing, including: first and second orthogonally oriented two-dimensional liquid crystal display panels, respectively coupled with said first and second video component signals, to produce first and second two-dimensional polarized images; a 90 degree polarization rotation plate disposed on one of said LCD panels, so that said first and second images are orthogonally polarized; and a polarization-sensitive reflector disposed angularly between said first and second LCD panels, said reflector being operative to superimpose and direct both of said first and second orthogonally polarized images toward a viewer.

Further features and advantages of the invention will become more readily apparent from the following detailed description when taken in conjunction with the accompanying drawings.

### BRIEF DESCRIPTION OF THE DRAWING

FIG. 1 is a schematic diagram of an apparatus in accordance with an embodiment of the invention, and which can be used in practicing an embodiment in accordance with a method of the invention

### DETAILED DESCRIPTION

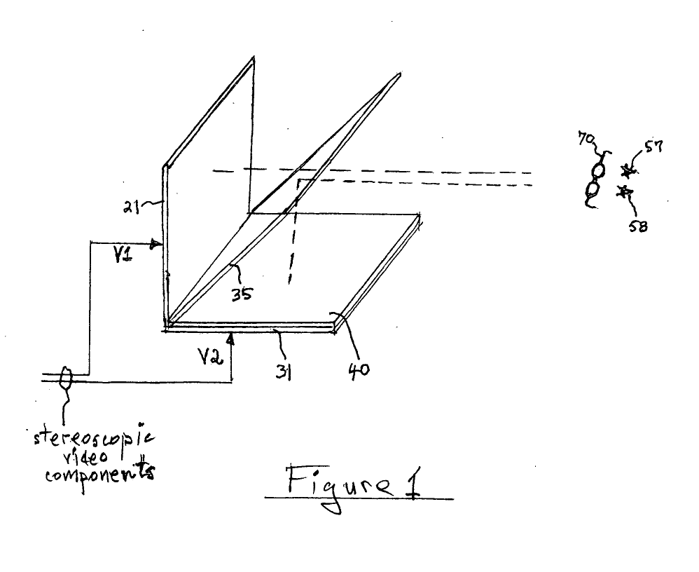

FIG. 1 shows a diagram of an embodiment of an apparatus in accordance with the invention, and which can be used in practicing an embodiment of the method of the invention.

As is well known in the art, the illusion of depth in a movie or video can be created by presenting a slightly different image to each eye. Two video component signals can be obtained using two suitably positioned cameras, or by other known means. In the FIGURE, two stereoscopic video component signals, representative of a 3D image, are designated V1 and V2. Two liquid crystal display (LCD) panels 21 and 31 respectively receive the video component signals V1 and V2. In the embodiment of FIG. 1, the LCD panels 21 and 31 are orthogonally oriented; that is, with the panel 31 oriented horizontally and facing upward, and the panel 21 oriented vertically and facing a viewer, whose eyes are represented at 57, 58. The LCD panels may be commercially available 56 inch color LCDs in the 4K format.

An inherent characteristic of the LCD display panels is that the light output from each panel is already polarized. Therefore, there is no light loss resulting from the need for polarizing the light, as in the above-summarized prior art system. A polarization sensitive mirror 35 is angularly disposed between the LCD and panels 21 and 22, at an angle of 45 degrees. Both display panels will normally have the same direction of polarization. In the present embodiment, the image from one of the LCD panels has its direction of polarization rotated by 90 degrees, so that the two images (from the two respective LCD panels) can be superimposed and then distinctly viewed as separated stereoscopic images by a viewer, using Polaroid glasses (that is, glasses that have left and right orthogonal polarizing filters, each filter passing only light that is similarly polarized, and blocking the orthogonally polarized light—each eye thereby seeing only its separately polarized image, thus obtaining the desired three-dimensional effect). The Polaroid glasses are represented at 70.

In the example of FIG. 1, the 90 degree polarization rotation is implemented on the light of the image from panel 31 using a 90 degree twist static LCD plate 40. Plates of this type are well known in the art, and serve to rotate the polarization of all colors by 90 degrees with almost no loss of light. The direction of polarization of the transmitted and reflected light from the panels has to correspond to the polarization of the direct and rotated light from the panels.

The image will appear to the viewer like a 3D image viewed through a 56″ diagonal window. In this example, the size of the bottom display (31) limits the minimum viewing distance to about 30″. It can be viewed at up to 45″ before the viewer's eyes start to limit the perception of detail. It is assumed that an older viewer will be wearing glasses correcting vision for the viewing distance.

1. A method for three-dimensional viewing, comprising the steps of:
providing first and second stereoscopic video component signals representative of a three-dimensional scene;
providing first and second orthogonally oriented two-dimensional liquid crystal display panels, and respectively coupling said first and second video component signals to said first and second LCD panels to produce first and second two-dimensional polarized images;
providing a 90 degree polarization rotation with respect to one of said first and second images, so that said first and second images are orthogonally polarized;
providing a polarization-sensitive reflector angularly between said first and second orthogonally polarized images to superimpose and direct both of said first and second orthogonally polarized images toward a viewer; and
viewing said superimposed first and second orthogonally polarized images with Polaroid glasses.

2. The method as defined by claim 1, wherein said step of providing a 90 degree polarization rotation comprises providing a 90 degree twist plate over one of said first or second LCD panels.

3. The method as defined by claim 1, wherein said step of providing a polarization sensitive reflector comprises providing a polarization sensitive mirror at an angle of 45 degrees between said orthogonally oriented LCD panels.

4. The method as defined by claim 2, wherein said step of providing a polarization sensitive reflector comprises providing a polarization sensitive mirror at an angle of 45 degrees between said orthogonally oriented LCD panels.

5. The method as defined by claim 2, wherein said step of providing first and second orthogonally oriented LCD panels comprises providing first and second orthogonally oriented 56 inch LCD panels.

6. The method as defined by claim 4, wherein said step of providing first and second orthogonally oriented LCD panels comprises providing first and second orthogonally oriented 56 inch LCD panels.

7. The method as defined by claim 1, wherein said step of providing first and second orthogonally oriented LCD panels comprises providing one of said LCD panels facing upwards and the other of said LCD panels facing a viewer.

8. Apparatus for receiving first and second stereoscopic video component signals representative of a three-dimensional scene, and providing orthogonally polarized images for stereoscopic viewing, comprising;
first and second orthogonally oriented two-dimensional liquid crystal display panels, respectively coupled with said first and second video component signals, to produce first and second two-dimensional polarized images;
a 90 degree polarization rotation plate disposed on one of said LCD panels, so that said first and second images are orthogonally polarized; and
a polarization-sensitive reflector disposed angularly between said first and second LCD panels, said reflector being operative to superimpose and direct both of said first and second orthogonally polarized images toward a viewer.

9. Apparatus as defined by claim 8, wherein said 90 degree polarization rotation plate comprises a 90 degree twist plate disposed over one of said first or second LCD panels.

10. Apparatus as defined by claim 8, wherein said polarization sensitive reflector comprises a polarization sensitive mirror at an angle of 45 degrees between said orthogonally oriented LCD panels.

11. Apparatus as defined by claim 9, wherein said polarization sensitive reflector comprises a polarization sensitive mirror at an angle of 45 degrees between said orthogonally oriented LCD panels.

12. Apparatus as defined by claim 9, wherein said first and second orthogonally oriented LCD panels comprise first and second orthogonally oriented 56 inch LCD panels.

13. Apparatus as defined by claim 11, wherein said first and second orthogonally oriented LCD panels comprise first and second orthogonally oriented 56 inch LCD panels.

14. Apparatus as defined by claim 8, wherein said first and second orthogonally oriented LCD panels comprise an LCD panel facing upwards and the other LCD panel facing a viewer.
